(19) United States
(12) Patent Application Publication
(10) Pub. No.: US 2007/0271325 A1
(43) Pub. Date: Nov. 22, 2007

(54) Matrix multiply with reduced bandwidth requirements

(75) Inventors: Norbert Juffa, San Jose, CA (US); John R. Nickolls, Los Altos, CA (US)

Correspondence Address: PATTERSON & SHERIDAN, L.L.P., 3040 POST OAK BOULEVARD, SUITE 1500, HOUSTON, TX, 77056, US

(73) Assignee: NVIDIA Corporation

(21) Appl. No.: 11/430,324

(22) Filed: May 8, 2006

(51) Int. Cl. G06F 7/52

(52) U.S. Cl. 708/607

(57) ABSTRACT

Systems and methods for reducing the bandwidth needed to read the inputs to a matrix multiply operation may improve system performance. Rather than reading a row of a first input matrix and a column of a second input matrix to produce a column of a product matrix, a column of the first input matrix and a single element of the second input matrix are read to produce a column of partial dot products of the product matrix. Therefore, the number of input matrix elements read to produce each product matrix element is reduced from 2N to N+1, where N is the number of elements in a column of the product matrix.

### BACKGROUND OF THE INVENTION

1. Field of the Invention

Embodiments of the present invention generally relate to performing matrix multiplication using multi-threaded processing or vector processing and, more specifically, to reducing memory bandwidth.

2. Description of the Related Art

Matrix-matrix multiplication is an important building block for many computations in the high-performance computing field. Each multiply-add operation used to perform the matrix-matrix multiplication requires access to two source operands in memory. Therefore, in a multi-threaded processor which executes T threads simultaneously, each of which performs a multiply-add operation, 2T memory operands are required to source the operands for the multiply portion of the operation. Similarly, in a vector processor which executes T data lanes in parallel, such as a T-lane single instruction multiple data (SIMD) vector processor, 2T memory operands are required per vector multiply-add. In general, providing the memory bandwidth for 2T simultaneous accesses becomes increasingly harder as T increases, and the matrix multiplication thus becomes memory bandwidth limited for sufficiently large T. This limits the overall computational performance of a processing device for matrix multiply.

Accordingly, there is a desire to reduce the memory bandwidth needed to source the operands for the multiply-add operations to improve the computational performance for matrix multiplication.

### SUMMARY OF THE INVENTION

The current invention involves new systems and methods for reducing memory bandwidth requirements for matrix multiplication using a multi-threaded processor. Memory bandwidth requirements may be reduced by performing the multiplication of two matrices in such a way that in a given step of the matrix multiplication, a group of T execution threads or T vector lanes share one of the two source operands to their respective multiply-add operations. This is exploited by the inclusion of an operand broadcast mechanism within the multi-threaded processing device. The broadcast mechanism allows the content of one memory location to be broadcast to all T threads in a thread group or to all T lanes of a vector, where the value can be used as source operands to executing instructions, including the instruction or instructions constituting the multiply-add operation. The mechanism provides means for software to control this broadcast transfer. When the broadcast mechanism is used the memory bandwidth requirements needed to perform operations such as a multiply-add may be reduced.

For each simultaneously executed multiply-add operation, the T execution threads of the thread group only access T+1 memory locations, as opposed to 2T memory locations when a conventional method of performing matrix multiplication is used. Reducing the memory bandwidth needed to obtain the operands for the matrix multiply operation may improve the matrix multiplication performance when the memory bandwidth is limited. Furthermore, the performance of other memory bandwidth limited operations may be improved.

Various embodiments of a method of the invention for executing a program instruction for multiple threads in a thread group include obtaining a first value specified by a broadcast operand included with the program instruction and obtaining a set of second values specified by the parallel operand included with the program instruction, wherein each one of the second values corresponds to one of the multiple threads in the thread group. The first value is provided to multiple program instruction execution units, the second values are provided to the multiple program instruction execution units, and the program instruction is executed for each one of the multiple threads in the thread group.

Various embodiments of a method of the invention for multiplying a first matrix and a first column of a second matrix to produce a first column of a product matrix includes multiplying each element of a first column of the first matrix by first element of the first column of the second matrix to produce a first group of elements corresponding to the first column of the product matrix, storing the first group of elements corresponding to a column of the product matrix in a set of registers, multiplying each element of a second column of the first matrix by a second element of the first column of the second matrix to produce a second group of elements corresponding to the first column of the product matrix, summing each element of the stored group of elements with a corresponding element of the second group of elements to produce a group of product elements within the first column of the product matrix, and storing the group of product elements in the set of registers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a conceptual diagram of matrix A and matrix B that are multiplied to produce matrix C in accordance with one or more aspects of the present invention.

FIG. 1B illustrates a flow diagram of an exemplary method of multiplying matrix A and matrix B to produce matrix C in accordance with one or more aspects of the present invention.

FIG. 1C illustrates a conceptual block diagram of multiple execution units receiving parallel operands and a broadcast operand in accordance with one or more aspects of the present invention.

FIG. 2 illustrates a flow diagram of an exemplary method of executing an instruction that includes a broadcast operand in accordance with one or more aspects of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

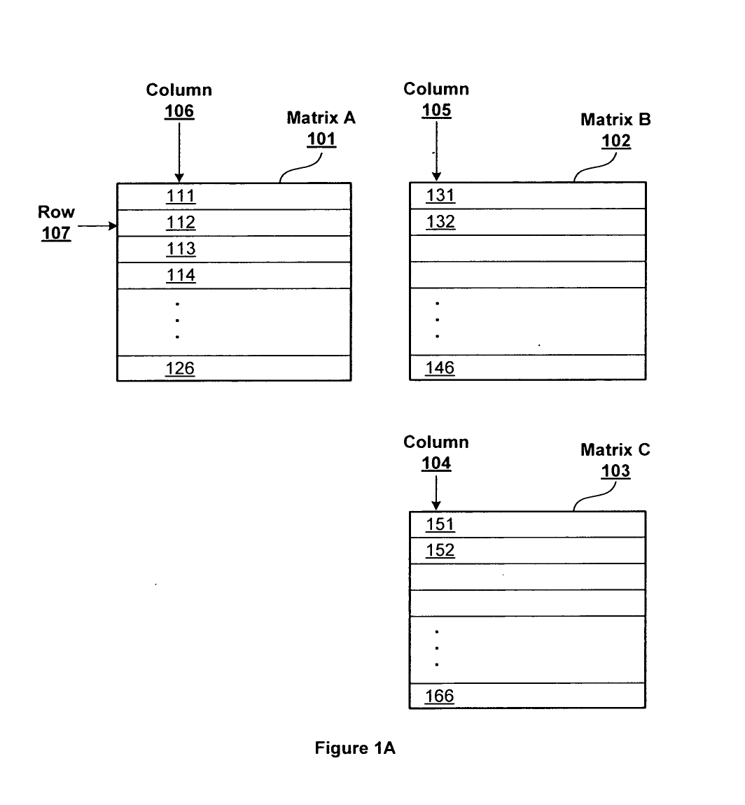

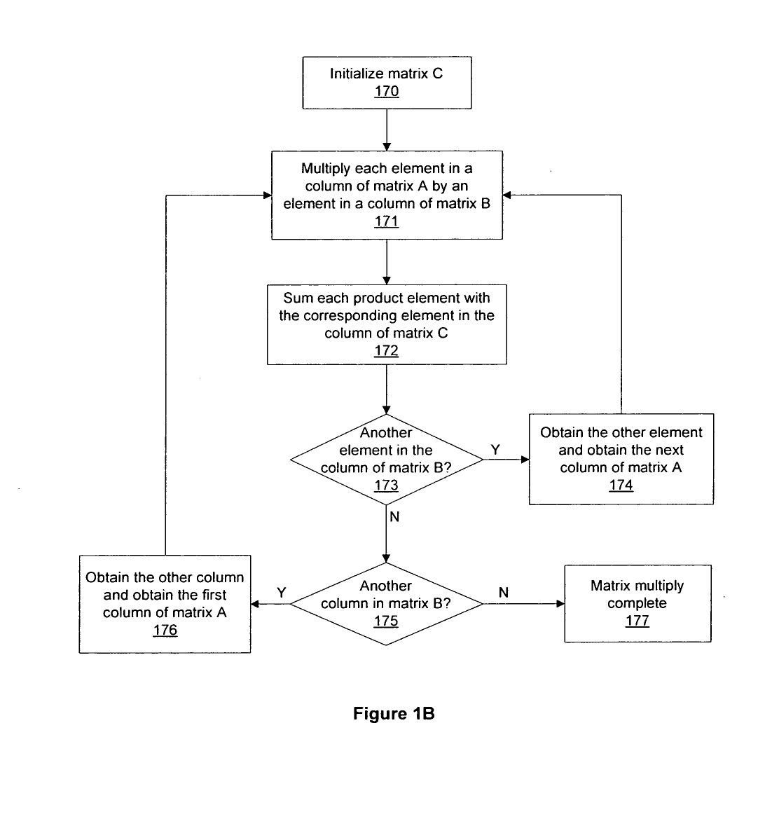

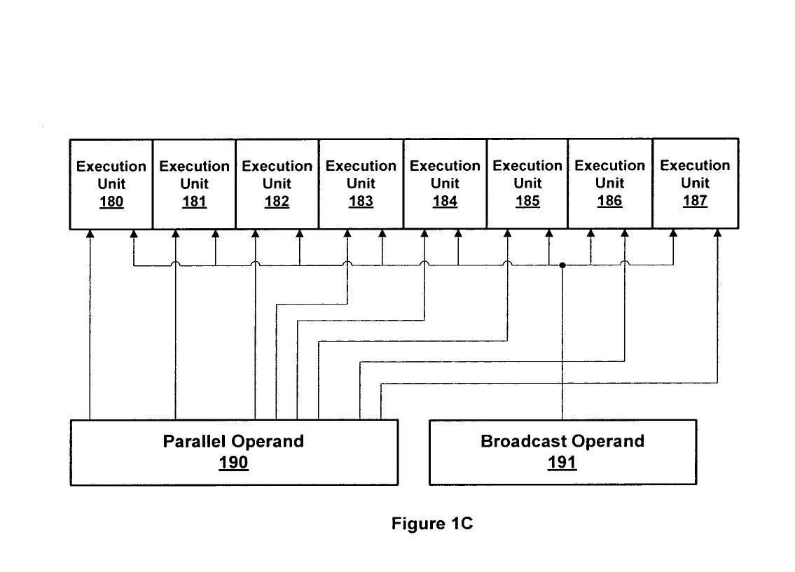

FIG. 1A illustrates a conceptual diagram of a matrix A 101 and a matrix B 102 that are multiplied to produce a matrix C 103, in accordance with one or more aspects of the present invention. Conventionally, a dot product is computed using the elements in a row of matrix A 101 and a column of matrix B 102 to produce an element of a column of matrix C 103. For example the elements in row 107 of matrix A 101 and the elements, e.g., 131, 132, and 146, in column 105 of matrix B 102, are used to produce element 152 in column 104 of matrix C 103. When multiple execution threads are used in a conventional system to produce matrix C 103, with each thread producing an element of matrix C, each thread reads an element from matrix A 101 and an element from matrix B 102 to perform successive multiply-add operations that produce a column (or row) of matrix C 103. As previously described, in a conventional system 2T elements are read for each one of the multiply-add operations when T threads are processed in parallel.

In the present invention, rather than reading multiple elements from matrix A 101 and multiple elements from matrix B 102 to produce a column of matrix C 103, a column of matrix A 101 and a single element of matrix B 102 are read to produce a column of partial dot products of matrix C 103. For example, column 106 and element 131 of column 105 may be read and multiplied to produce a column of products. The column of products, i.e., product of element 111 and element 131, product of element 112 and element 131, product of element 113 and element 131, product of element 114 and element 131, and so on) is then summed with column 104 to update the partial dot products for column 104. Additional columns of products are computed using columns of matrix A 101 and elements of column 105 of matrix B 102. The additional columns of products are successively accumulated with the column of partial dot products until the column of partial dot products is complete. Therefore, each thread reads an element from one column of matrix A 101, and a single element from one row of matrix B 102 is read and shared by all of the threads to perform a multiply-add. The number of input matrix elements read to produce each partial dot products column of matrix C 103 is reduced from 2T to T+1. Each element read from matrix B 102 is broadcast to T threads to be multiplied by an element of a column of matrix A 101.

FIG. 1B illustrates a flow diagram of an exemplary method of multiplying matrix A and matrix B to produce matrix C in accordance with one or more aspects of the present invention. In step 170 registers or memory locations storing the elements of matrix C 103 are initialized. For example, each element may be initialized to a value of 0. In step 171 each element in a first column of matrix A 101 is multiplied by one element in a column of matrix B 102. For example, a first thread multiplies element 111 by element 131, a second thread multiplies element 112 by element 131, and so on, to produce a column of product elements. In step 172 each product element produced in step 171 is summed with a corresponding element in a column of matrix C 103. For example, the product of element 111 and 131 is summed with element 151 to accumulate a partial dot product.

In step 173 the method determines if another element is present in the column of matrix B 102. For example, after element 131 has been used to accumulate the partial dot products for column 104 of matrix C 103, element 132 will be used, and so on, until the last element in the column, element 146, is used. If, in step 173 the method determines that all of the elements in the column of matrix B 102 have been used, then the method proceeds to step 175. Otherwise, in step 174 the method obtains the next element in the column of matrix B 102 and obtains the next column of matrix A 174 and repeats steps 171, 172, and 173 to accumulate another product into each partial dot product for column 104 of matrix C 103. The elements in the column of matrix B 102 do not need to be used in any particular order, just as long as each element is used to produce a product with the corresponding column of matrix A 101.

In step 175 the method determines if another column is present in matrix B 102, and, if not, the method proceeds to step 177 and the matrix multiplication operation is complete. Otherwise, in step 176 the method obtains an unused column of matrix B 102 and obtains the first column of matrix A 101. Steps 171, 172, 173, and 174 are repeated to produce another column of matrix C 103.

FIG. 1C illustrates a conceptual block diagram of multiple program instruction execution units that each receive a broadcast operand in accordance with one or more aspects of the present invention. The multiple program instruction execution units may be configured to reduce the bandwidth needed to obtain the source operands, i.e., elements of matrix A 101 and matrix B 102, to produce matrix C 103. Each program instruction execution unit, execution unit 180, 181, 182, 183, 184, 185, 186, and 187 is configured to produce at least one element of matrix C 103. Execution units 180, 181, 182, 183, 184, 185, 186, and 187 may be configured to execute a program instruction in parallel. For example, each one of the execution units may process a thread within a group of multiple threads to execute the program instruction for multiple threads in parallel, such as in a multithreaded processor. In another example, each one of the execution units may process a lane within a group of multiple lanes to execute the program instruction for multiple lanes in parallel, such as in a single instruction multiple data (SIMD) vector processor.

Each execution unit receives one unique parallel operand from parallel operand 190. The elements of matrix A 101 may be the parallel operands. Each execution unit also receives one broadcast operand from broadcast operand 191. The same broadcast operand is output by broadcast operand 191 to each execution unit. The elements of matrix B 102 may be the broadcast operands. In other embodiments of the present invention, matrix A 101 and matrix B 102 are reversed and matrix A 101 provides the broadcast operands and matrix B 102 provides the parallel operands.

For each simultaneously executed multiply-add operation, the T execution units only access T+1 memory locations, as opposed to 2T memory locations when a conventional method of performing matrix multiplication is used. When the broadcast mechanism is used the memory bandwidth requirements needed to perform operations such as a multiply-add may be reduced. Consequently, when processing performance is limited by the memory bandwidth performance may be improved, possibly nearly doubled by using the broadcast mechanism. Although the broadcast mechanism has been described in the context of matrix-matrix multiplication, specifically multiply-add operations, the broadcast mechanism may be used to perform other operations during multi-threaded processing. Examples of other operations include minimum, maximum, addition, subtraction, sum of absolute differences, sum of squared differences, multiplication, and division.

Conventional processing systems perform matrix-matrix multiplies by subdividing the operation, possibly at several levels to efficiently exploit multiple levels of a memory hierarchy consisting of memory devices of different performance, e.g., throughput, latency, or the like. The subdivision results in the matrix multiply of a large matrix being decomposed into matrix multiplies of portions of the total matrix called tiles. On processing devices coupled to at least two levels of memory hierarchy of different speeds, matrix multiplication can be sped up by copying tiles from both source matrices stored in a slower level of the memory hierarchy to a faster level of the memory hierarchy, multiplying the tiles into a result tile, and copying back the result tile to the appropriate part of the result matrix stored in the slower level of the memory hierarchy.

Tiling techniques for performing matrix multiplication are known to those skilled in the art. Systems and methods of the present invention may be applied to compute elements in each tile of a product matrix. In particular, the broadcast mechanism may be used to compute elements of a tile, where matrix A 101, matrix B 102, and matrix C 103 are each a tile of larger matrices. Similarly, matrix-vector multiplication is subsumed as a special case of a matrix whose one dimension is unity.

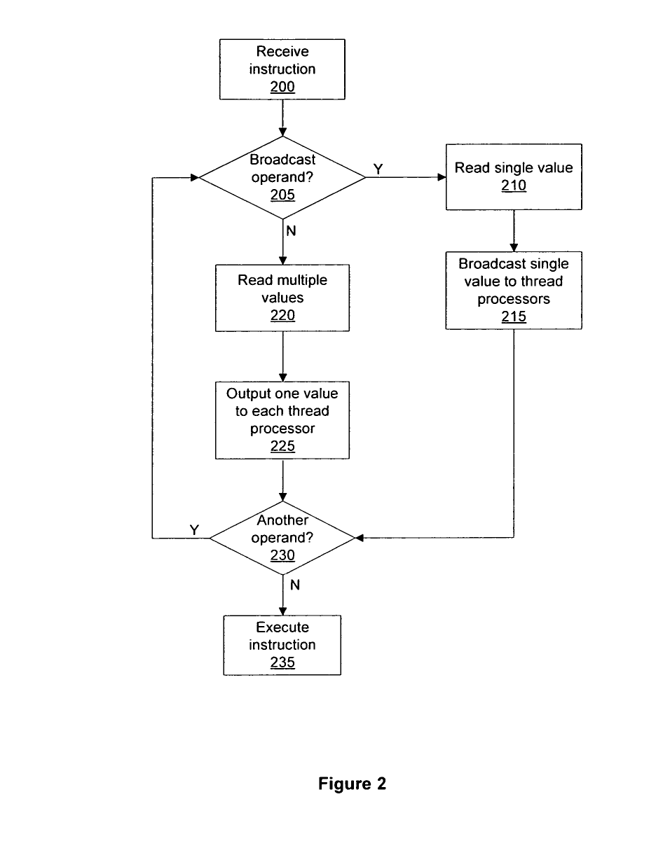

FIG. 2 illustrates a flow diagram of an exemplary method of executing an instruction that includes a broadcast operand in accordance with one or more aspects of the present invention. In step 200 the method receives an instruction including one or more operands for multi-threaded processing. In step 205 the method determines if a first operand is a broadcast operand. There are a variety of techniques that may be used to specify that a particular operand is a broadcast operand. One such technique is to define instructions that include an operand that is specified by the instruction format as a broadcast operand. For example, two different load instructions may be defined, one that includes a parallel operand and another that includes a broadcast operand.

The code shown in Table 1 represents a set of operations or instructions for T parallel execution units of a multi-threaded or vector processor as shown in FIG. 1C, that may be used to perform T multiply-add operations for matrix-matrix multiplication.

TABLE 1

| | |
|---|---|
| LD A, M[A1 + offsetA] | // Load T elements of matrix A |
| LDB B, M[A2 + offsetB] | // Load and broadcast 1 element of matrix B |
| FMAD C, A, B, C | // C = A*B+C for T elements of C |

The LD instruction includes a parallel operand for T threads or T vector lanes specifying a memory address for each thread or lane, A1+offsetA, where A1 may be the base address for a matrix tile, matrix, column, or the like, and offsetA may be an offset for a particular column or portion of a column. The offsetA may be omitted. The effective address varies with each thread or lane, e.g. with T address registers A1, one per thread or lane, initialized with different addresses for each thread or lane. The T elements stored in the T memory locations specified by T addresses A1+offsetA are loaded into register A of each execution unit. A different memory location is read by each execution unit processing a thread or lane. Therefore, address A1+offsetA may vary with a unique thread or lane identifier to specify a different memory location for each thread or lane. For example, an address register A1 in each thread or lane is initialized with a different address, varying with the thread or lane identifier.

The LDB instruction includes a broadcast operand specifying memory address, A2+offsetB, where A2 may be the base address for a matrix tile, matrix, column, or the like, and offsetB may be an offset for a particular column or portion of a column. The element stored in the memory location specified by A2+offsetB is loaded into register B of each execution unit. Unlike the LD instruction, where A1+offsetA has a different value for each thread or lane, A2+offsetB has the same value for all of the threads in the thread group or lanes in a vector. Finally, the FMAD (floating point multiply-accumulate) instruction is executed by each execution unit to perform the multiply-add function using registers A, B, and C. In other embodiments of the present invention, an IMAD (integer multiply-accumulate) instruction is used to perform the multiply-add function. In still other embodiments of the present invention, another computation, e.g., addition, subtraction, or the like, may be represented by an instruction to produce a result based on a broadcast operand.

In some embodiments of the present invention, the functionality provided by the set of operations shown in Table 1 may be achieved using fewer instructions. For example, the LD and LDB instructions may be combined into a single instruction that is provided in a dual issue manner with the FMAD instruction for parallel execution. In another example, the LD, LDB, and FMAD instructions may be combined to form a combined wide instruction that is provided to multiple execution units for parallel execution.

Another technique that may be used to specify that a particular operand is a broadcast operand is to define specific memory addresses that are within broadcast memory regions. For example, in Table 1, the LDB instruction may be replaced by a LD instruction where A2+offsetB corresponds to a memory address within a broadcast memory region. When an address within the broadcast memory region is specified, only one memory location is read and the data stored in the one location is broadcast to each field of the destination (B).

Yet another technique that may be used to specify that a particular operand is a broadcast operand is to define specific registers that are broadcast to each execution unit. For example, in Table 1, the LDB instruction would load a single register, .e.g, register B, rather than broadcasting the element stored in the memory location specified by A2+offsetB to each execution unit. Register B would be specified as a broadcast register and when register B is specified as an operand for an instruction, such as the FMAD instruction in Table 1, the value stored in register B is broadcast to each execution unit in order to execute the instruction.

If, in step 205 the method determines that the first operand is a broadcast operand, then in step 210 the method reads a single value specified by the operand. In step 215 the single value is broadcast to each of the execution units. In embodiments of the present invention that specify one or more broadcast registers the single value is loaded into a broadcast register and then broadcast to the execution units. If, in step 205 the method determines that the first operand is not a broadcast operand, i.e., the first operand is a parallel operand then in step 220 the method reads the values specified by the operand. A different value may be read by each execution unit for each thread or lane, i.e., the number of values equals the number of threads or lanes executing. In step 225 the read values are output (parallel) to the execution units.

In step 230 the method determines if another operand is specified for the instruction, and, if so, the method returns to step 205. Otherwise, the method proceeds to execute the instruction to produce a result using the parallel and/or broadcast values provided to the execution units. Note that the instruction may represent a single operation, such as a load or computation, or the instruction may represent a combination of operations, such as multiple loads and/or a computation.

Persons skilled in the art will appreciate that any system configured to perform the method steps of FIG. 1B or 2, or their equivalents, is within the scope of the present invention. Memory bandwidth requirements may be reduced by performing the multiplication of two matrices in such a way that in a given step of the matrix multiplication, a group of T execution threads or lanes share one of the two source operands to their respective multiply-add operations. This is exploited by the inclusion of an operand broadcast mechanism within a parallel processing device, such as a multi-threaded processor or a SIMD vector processor.

The broadcast mechanism allows the content of one memory location to be broadcast to all T threads in a thread group (or to all T lanes in a SIMD vector processor), where the value can be used as source operands to executing instructions, including the instruction or instructions for performing matrix operations. Software can control this broadcast transfer by specifying broadcast memory regions and program instructions that include one or more broadcast operands. When the broadcast mechanism is used the memory bandwidth requirements needed to perform operations such as a multiply-add may be reduced, thereby improving performance when memory bandwidth is limited.

While the foregoing is directed to embodiments of the present invention, other and further embodiments of the invention may be devised without departing from the basic scope thereof, and the scope thereof is determined by the claims that follow. The foregoing description and drawings are, accordingly, to be regarded in an illustrative rather than a restrictive sense. The listing of steps in method claims do not imply performing the steps in any particular order, unless explicitly stated in the claim.

All trademarks are the respective property of their owners.

The invention claimed is:

1. A method of executing a set of operations including a broadcast operand for multiple threads or lanes, comprising:
obtaining a first value specified by the broadcast operand included with the set of operations;
providing the first value to multiple program instruction execution units;
obtaining a set of second values specified by the parallel operand included with the set of operations, wherein each one of the second values corresponds to one of the multiple threads or lanes;
providing one second value of the set of second values to each one of the multiple program instruction execution units; and
executing the set of operations for each one of the multiple threads or lanes.

2. The method of claim 1, further comprising determining that a memory operand included in the set of operations is the broadcast operand based on a format specified for the set of operations.

3. The method of claim 1, further comprising determining that a memory operand included in the set of operations is the broadcast operand based on an address specified for the memory operand.

4. The method of claim 1, further comprising determining that a source operand included in the set of operations is the broadcast operand based on a register specified for the source operand.

5. The method of claim 1, wherein the first value and the second values are represented in a fixed point data format.

6. The method of claim 1, wherein the first value and the second values are represented in a floating point data format.

7. The method of claim 1, wherein the set of operations includes a multiply-add operation.

8. The method of claim 1, wherein the set of operations is represented as a single program instruction including the broadcast operand, the parallel operand, and a computation used to produce a result based on the broadcast operand.

9. The method of claim 1, wherein the set of operations is represented as a first load program instruction including the broadcast operand and the parallel operand and a second program instruction specifying a computation used to produce a result based on the broadcast operand.

10. The method of claim 1, wherein the set of operations is represented as a first load program instruction including the broadcast operand, a second load program instruction including the parallel operand, and a third program instruction specifying a computation used to produce a result based on the broadcast operand.

11. The method of claim 1, wherein the broadcast operand specifies an address that has a single value for each one of the multiple threads.

12. The method of claim 1, wherein the parallel operand specifies an address that has a different value for each one of the multiple threads.

13. A method of multiplying a first matrix and a first column of a second matrix to produce a first column of a product matrix, comprising:
multiplying each element of a first column of the first matrix by first element of the first column of the second matrix to produce a first group of elements corresponding to the first column of the product matrix;
storing the first group of elements corresponding to a column of the product matrix in a set of registers;
multiplying each element of a second column of the first matrix by a second element of the first column of the second matrix to produce a second group of elements corresponding to the first column of the product matrix;
summing each element of the stored group of elements with a corresponding element of the second group of elements to produce a group of product elements within the first column of the product matrix; and
storing the group of product elements in the set of registers.

14. The method of claim 13, wherein the first matrix is a tile of a third matrix, the second matrix is a tile of a fourth matrix, and the product array is a tile of a fifth matrix.

15. The method of claim 13, further comprising:
multiplying each element of each remaining column of the first matrix by a remaining element of the first column of the second matrix to produce additional groups of elements corresponding to the first column of the product matrix;
summing each element of the stored group of product elements with a corresponding element of one of the additional groups of elements to produce an additional group of product elements within the first column of the product matrix;
storing the additional group of product elements in the set of registers;
summing each element of the stored additional group of product elements with remaining corresponding elements of the additional groups of elements to produce a complete group of product elements within the first column of the product matrix;
storing the complete group of product elements in the set of registers.

16. The method of claim 15, wherein the steps of multiplying, storing, and summing are repeated for each remaining column of the second matrix to produce each remaining column of the product matrix.

17. A computer readable medium storing instructions for causing a processor to multiply a first matrix and a first column of a second matrix to produce a first column of a product matrix, by performing the steps of:
multiplying each element of a first column of the first matrix by first element of the first column of the second matrix to produce a first group of elements corresponding to the first column of the product matrix;
storing the first group of elements corresponding to a column of the product matrix in a set of registers;
multiplying each element of a second column of the first matrix by a second element of the first column of the second matrix to produce a second group of elements corresponding to the first column of the product matrix;
summing each element of the stored group of elements with a corresponding element of the second group of elements to produce a group of product elements within the first column of the product matrix; and
storing the group of product elements in the set of registers.

18. The computer readable medium of claim 17, further comprising:
multiplying each element of each remaining column of the first matrix by a remaining element of the first column of the second matrix to produce additional groups of elements corresponding to the first column of the product matrix;
summing each element of the stored group of product elements with a corresponding element of one of the additional groups of elements to produce an additional group of product elements within the first column of the product matrix;
storing the additional group of product elements in the set of registers;
summing each element of the stored additional group of product elements with remaining corresponding elements of the additional groups of elements to produce a complete group of product elements within the first column of the product matrix;
storing the complete group of product elements in the set of registers.

19. The computer readable medium of claim 18, wherein the steps of multiplying, storing, and summing are repeated for each remaining column of the second matrix to produce each remaining column of the product matrix.

20. The computer readable medium of claim 17, wherein the first matrix is a tile of a third matrix, the second matrix is a tile of a fourth matrix, and the product array is a tile of a fifth matrix.
